(19) United States
(12) Patent Application Publication
(10) Pub. No.: US 2025/0138812 A1
(43) Pub. Date: May 1, 2025

(54) AUTOMATION OF WEB ELEMENT CHANGES FOR ENHANCED APPLICATION TESTING EFFICIENCY

(71) Applicant: Dell Products L.P., Round Rock, TX (US)

(72) Inventors: Shibi Panikkar, Bangalore (IN); Subhashini Puram, Hyderabad (IN); Aashna Mohapatra, Bhubaneswar (IN); Ambarish Roy, Guwahati (IN)

(73) Assignee: Dell Products L.P., Round Rock, TX (US)

(21) Appl. No.: 18/495,026

(22) Filed: Oct. 26, 2023

(51) Int. Cl. G06F 8/70; G06F 11/36

(52) U.S. Cl. CPC G06F 8/70; G06F 11/3604

(57) ABSTRACT

An example methodology includes, by a computing device, traversing through one or more locators to validate the one or more locators, wherein each locator of the one or more locators is for an element on a page of an application. The method also includes, responsive to a determination of a failure of a locator to identify a current element on a page of the application, by the computing device, identifying a new element on the page of the application, wherein the new element is identified based on the current element, generating a new locator for the failed locator based on the new element, and updating a web elements repository for the application with the new locator.

### BACKGROUND

Web application testing is the process of ensuring quality by testing that the functionality of a given web application is working as intended. Testing allows a developer of a web application to identify and fix bugs (defects) in the web application before they cause problems for users. By verifying that the web application is functioning properly, the web application developer can ensure that customers or users have a positive experience when using the web application. Organizations may desire to test the functionality of web applications, including the web elements, prior to releasing the web applications to production environments.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, traversing through one or more locators to validate the one or more locators, wherein each locator of the one or more locators is for an element on a page of an application. The method also includes, responsive to a determination of a failure of a locator to identify a current element on a page of the application, by the computing device, identifying a new element on the page of the application, wherein the new element is identified based on the current element, generating a new locator for the failed locator based on the new element, and updating a web elements repository for the application with the new locator.

In some embodiments, generating the new locator includes updating the failed locator with a new value corresponding to the new element.

In some embodiments, the new element is identified based on a similarity of the new element to the current element.

In some embodiments, the new element is identified based on a similarity score assigned to the new element based on how similar the new element is to the current element. In one aspect, the similarity score represents a similarity of one or more attributes of the new element to one or more attributes of the current element.

In some embodiments, the new locator has a same name as the failed locator.

In some embodiments, the new element has a same name as the current element.

In some embodiments, the one or more locators validated are stored within the web elements repository for the application.

According to another illustrative embodiment provided to illustrate the broader concepts described herein, a computing device includes one or more non-transitory machine-readable mediums configured to store instructions and one or more processors configured to execute the instructions stored on the one or more non-transitory machine-readable mediums. Execution of the instructions causes the one or more processors to carry out a process including traversing through one or more locators to validate the one or more locators, wherein each locator of the one or more locators is for an element on a page of an application. The process also includes, responsive to a determination of a failure of a locator to identify a current element on a page of the application, identifying a new element on the page of the application, wherein the new element is identified based on the current element, generating a new locator for the failed locator based on the new element, and updating a web elements repository for the application with the new locator.

According to another illustrative embodiment provided to illustrate the broader concepts described herein, a non-transitory machine-readable medium encodes instructions that when executed by one or more processors cause a process to be carried out, the process including traversing through one or more locators to validate the one or more locators, wherein each locator of the one or more locators is for an element on a page of an application. The process also includes, responsive to a determination of a failure of a locator to identify a current element on a page of the application, identifying a new element on the page of the application, wherein the new element is identified based on the current element, generating a new locator for the failed locator based on the new element, and updating a web elements repository for the application with the new locator.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a diagram showing integration of proactive web element change identification and mitigation process with a continuous integration and continuous deployment (CI/CD) pipeline for an application, in accordance with an embodiment of the present disclosure.

FIG. 5 is a block diagram of an illustrative system for proactive identification and mitigation of web element changes, in accordance with an embodiment of the present disclosure.

FIG. 6 is a flow diagram of an example process for identification and mitigation of web element changes, in accordance with an embodiment of the present disclosure.

### DETAILED DESCRIPTION

Web application testing entails the testing of elements of a web application to ensure that the application is fully functional. For example, a test engineer can manually perform the testing by launching the application, identifying the elements on the pages of the application to test, and clicking the elements to complete the test processes to verify that the elements function as intended. As this can be a tedious task, many organizations resort to application testing automation. Application testing automation is the concept of using software, such as automated test scripts, separate from the application being tested to control the execution of tests on an application. For example, many organizations use test automation tools, such as SELENIUM and APPIUM, to test their applications. However, even with such tools, the effort and expertise of the test automation engineer is needed to create accurate locators for the individual elements for use in test automation.

In today's digital environment, web applications are being constantly updated. While application updates can be a good thing, the updates often include changes to the locators. In the context of an application build, changes to the locators may cause the automated test scripts to run unsuccessfully and the application build to fail. For example, elements that no longer fit their initial “description” may mislead existing automation test scripts. For instance, when element properties change, a test script may fail, forcing a test automation engineer to cease creating new test scripts in order to troubleshoot and repair the failed test script. Manual item or element identification maintenance when a script fails can be time-consuming and inconvenient. Test script failure may also result in accumulation of application downtime.

Disclosed herein are computer-implemented structures and techniques for proactive identification and mitigation of web element (sometimes referred to herein more simply as “element”) changes. The techniques as variously disclosed herein automatically adapt changes to elements in an application (e.g., a web application) before performance of test automation to test the elements on the one or more pages of the application, for instance. The proactive identification and mitigation of changes to elements in an application reduces (and ideally minimizes) failure of test scripts to test the elements that in turn allows a test automation engineer to focus on test script development. In some embodiments, a web elements repository for an application can be leveraged to identify and mitigate changes to one or more elements in the application. The web elements repository for an application stores and/or contains information about the elements in the application (i.e., the elements on the one or more pages of the application), the attributes linked to the elements (i.e., attribution of the elements), and the locators for the elements (i.e., the locators used to identify the elements on the various pages of the application). Additional details regarding the web elements repository for an application, including generation and management of locators for the elements in the application, are provided in U.S. patent application Ser. No. 18/321,048, entitled: “Heterogenous Multi-Tenant Web Application Elements Handler,” filed May 22, 2023, which is incorporated herein by reference in its entirety.

In some such embodiments, a web elements repository for an application is traversed to identify and validate the correctness of the locators for the elements on the one or more pages of the application. For example, for a particular locator, the locator can be validated for effectiveness in identifying or addressing (or “locating”) an element on a page of the application. If the locator identifies an element on a page of the application, the locator can be verified to be correct and maintained as is within the web elements repository for the application. However, if the locator does not identify an element on a page of the application, the locator can be determined to be a failed locator. That is, if the current element that corresponds to the locator is not located in the application (e.g., the current element that corresponds to the locator fails to get verified), the locator can be determined to be a failed locator. For a failed locator, its current value (e.g., current element that correspond to the failed locator) in the web elements repository can be used to identify a new element (e.g., another element) on the page of the application, and a new locator for the failed locator can be generated based on the identified new element. The identified new element is different than the current element that corresponds to the failed locator. The new locator identifies the new element on the page of the application. The identified new element may be an element on the page of the application that is similar to the current element that corresponds to the failed locator. For example, a similarity algorithm or other distance measure technique can be used to identify a new element on the page of the application that is similar to the current element that corresponds to the failed locator. An element on the page of the application that is similar to the current element can be identified and used to generate the new locator with the expectation that a change to the current element that caused the locator failure is likely to be a minor change the current element. For example, a developer of the application may have changed one or two attributes of the current element.

In more detail, for each element on the page of the application, the similarity algorithm can be used to assign a similarity score to each element based on how similar the element is to the current element. In some embodiments, the similarity score for an element may represent the similarity of one or more attributes of the element to one or more attributes of the current element that corresponds to the failed locator. In some embodiments, the identified element may be an element on the page of the application that is most similar to the current element that corresponds to the failed locator. In some embodiments, the new locator is the failed locator with updated or new locator values to the identified new element. As a result, the new locator has the same name (i.e., locator name) as the failed locator. In some embodiments, the web elements repository for the application is updated with the new locator. For example, the failed locator in the web elements repository can be replaced with the new locator. Numerous aspects and features are described in detail below and will be apparent in light of this disclosure.

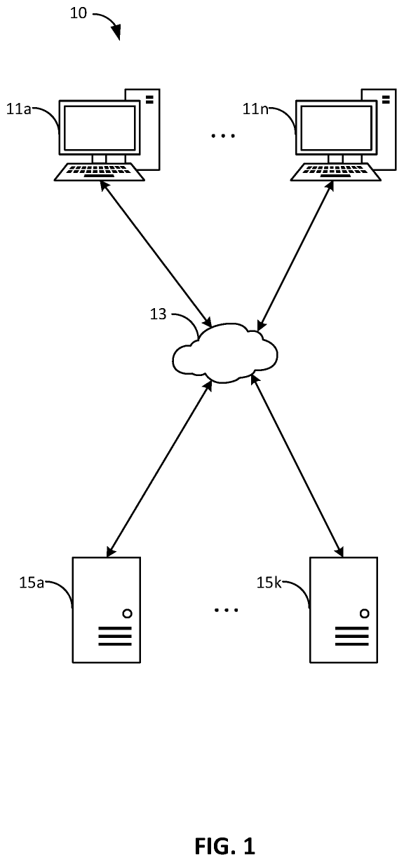

Referring now to FIG. 1, shown is a diagram illustrating an example network environment 10 of computing devices in which various aspects of the disclosure may be implemented, in accordance with an embodiment of the present disclosure. As shown, environment 10 includes one or more client machines 11a-11n (11 generally), one or more server machines 15a-15k (15 generally), and one or more networks 13. Client machines 11 can communicate with server machines 15 via networks 13. Generally, in accordance with client-server principles, a client machine 11 requests, via network 13, that a server machine 15 perform a computation or other function, and server machine 15 responsively fulfills the request, optionally returning a result or status indicator in a response to client machine 11 via network 13.

In some embodiments, client machines 11 can communicate with remote machines 15 via one or more intermediary appliances (not shown). The intermediary appliances may be positioned within network 13 or between networks 13. An intermediary appliance may be referred to as a network interface or gateway. In some implementations, the intermediary appliance may operate as an application delivery controller (ADC) in a datacenter to provide client machines (e.g., client machines 11) with access to business applications and other data deployed in the datacenter. The intermediary appliance may provide client machines with access to applications and other data deployed in a cloud computing environment, or delivered as Software as a Service (SaaS) across a range of client devices, and/or provide other functionality such as load balancing, etc.

Client machines 11 may be generally referred to as computing devices 11, client devices 11, client computers 11, clients 11, client nodes 11, endpoints 11, or endpoint nodes 11. Client machines 11 can include, for example, desktop computing devices, laptop computing devices, tablet computing devices, mobile computing devices, workstations, and/or hand-held computing devices. Server machines 15 may also be generally referred to as a server farm 15. In some embodiments, a client machine 11 may have the capacity to function as both a client seeking access to resources provided by server machine 15 and as a server machine 15 providing access to hosted resources for other client machines 11.

Server machine 15 may be any server type such as, for example, a file server, an application server, a web server, a proxy server, a virtualization server, a deployment server, a Secure Sockets Layer Virtual Private Network (SSL VPN) server; an active directory server; a cloud server; or a server executing an application acceleration program that provides firewall functionality, application functionality, or load balancing functionality. Server machine 15 may execute, operate, or otherwise provide one or more applications. Non-limiting examples of applications that can be provided include software, a program, executable instructions, a virtual machine, a hypervisor, a web browser, a web-based client, a client-server application, a thin-client, a streaming application, a communication application, or any other set of executable instructions.

In some embodiments, server machine 15 may execute a virtual machine providing, to a user of client machine 11, access to a computing environment. In such embodiments, client machine 11 may be a virtual machine. The virtual machine may be managed by, for example, a hypervisor, a virtual machine manager (VMM), or any other hardware virtualization technique implemented within server machine 15.

Networks 13 may be configured in any combination of wired and wireless networks. Network 13 can be one or more of a local-area network (LAN), a wide area network (WAN), a metropolitan area network (MAN), a virtual private network (VPN), a primary public network, a primary private network, the Internet, or any other type of data network. In some embodiments, at least a portion of the functionality associated with network 13 can be provided by a cellular data network and/or mobile communication network to facilitate communication among mobile devices. For short range communications within a wireless local-area network (WLAN), the protocols may include 802.11, Bluetooth, and Near Field Communication (NFC).

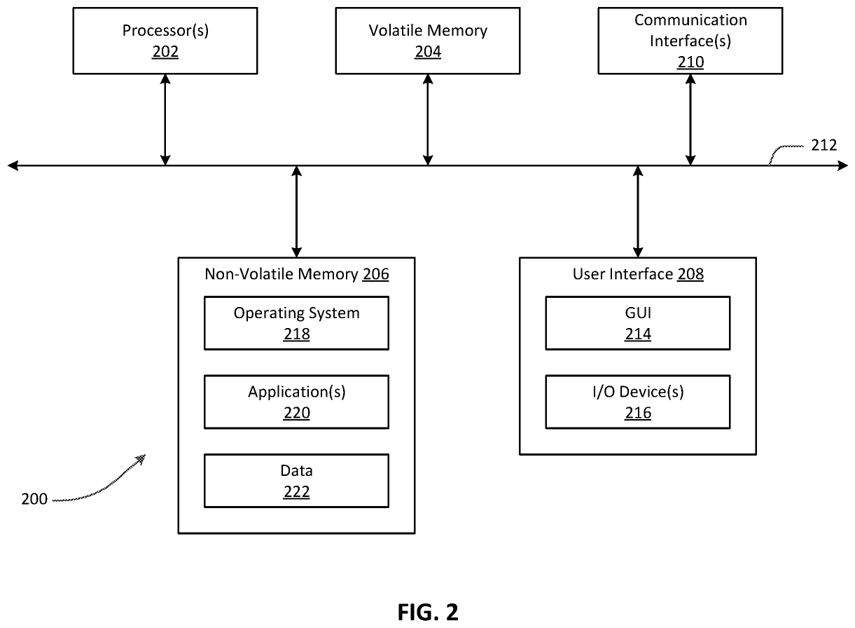

FIG. 2 is a block diagram illustrating selective components of an example computing device 200 in which various aspects of the disclosure may be implemented, in accordance with an embodiment of the present disclosure. For instance, client machines 11 and/or server machines 15 of FIG. 1 can be substantially similar to computing device 200. As shown, computing device 200 includes one or more processors 202, a volatile memory 204 (e.g., random access memory (RAM)), a non-volatile memory 206, a user interface (UI) 208, one or more communications interfaces 210, and a communications bus 212.

Non-volatile memory 206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 208 may include a graphical user interface (GUI) 214 (e.g., a touchscreen, a display, etc.) and one or more input/output (I/O) devices 216 (e.g., a mouse, a keyboard, a microphone, one or more speakers, one or more cameras, one or more biometric scanners, one or more environmental sensors, and one or more accelerometers, etc.).

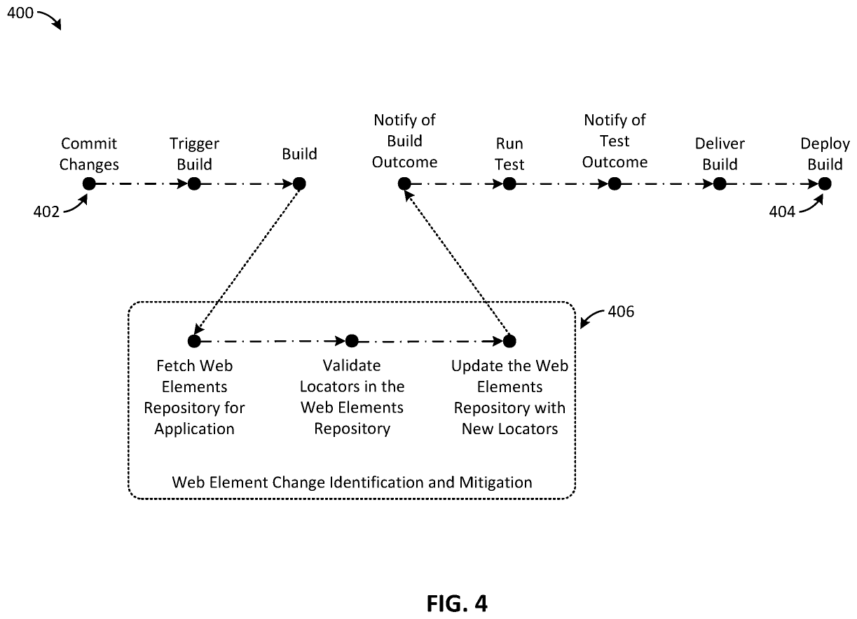

Non-volatile memory 206 stores an operating system 218, one or more applications 220, and data 222 such that, for example, computer instructions of operating system 218 and/or applications 220 are executed by processor(s) 202 out of volatile memory 204. In one example, computer instructions of operating system 218 and/or applications 220 are executed by processor(s) 202 out of volatile memory 204 to perform all or part of the processes described herein (e.g., processes illustrated and described with reference to FIGS. 4 through 6). In some embodiments, volatile memory 204 may include one or more types of RAM and/or a cache memory that may offer a faster response time than a main memory. Data may be entered using an input device of GUI 214 or received from I/O device(s) 216. Various elements of computing device 200 may communicate via communications bus 212.

The illustrated computing device 200 is shown merely as an illustrative client device or server and may be implemented by any computing or processing environment with any type of machine or set of machines that may have suitable hardware and/or software capable of operating as described herein.

Processor(s) 202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 202 may be analog, digital, or mixed signal. In some embodiments, processor 202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 210 may include one or more interfaces to enable computing device 200 to access a computer network such as a Local Area Network (LAN), a Wide Area Network (WAN), a Personal Area Network (PAN), or the Internet through a variety of wired and/or wireless connections, including cellular connections.

In described embodiments, computing device 200 may execute an application on behalf of a user of a client device. For example, computing device 200 may execute one or more virtual machines managed by a hypervisor. Each virtual machine may provide an execution session within which applications execute on behalf of a user or a client device, such as a hosted desktop session. Computing device 200 may also execute a terminal services session to provide a hosted desktop environment. Computing device 200 may provide access to a remote computing environment including one or more applications, one or more desktop applications, and one or more desktop sessions in which one or more applications may execute.

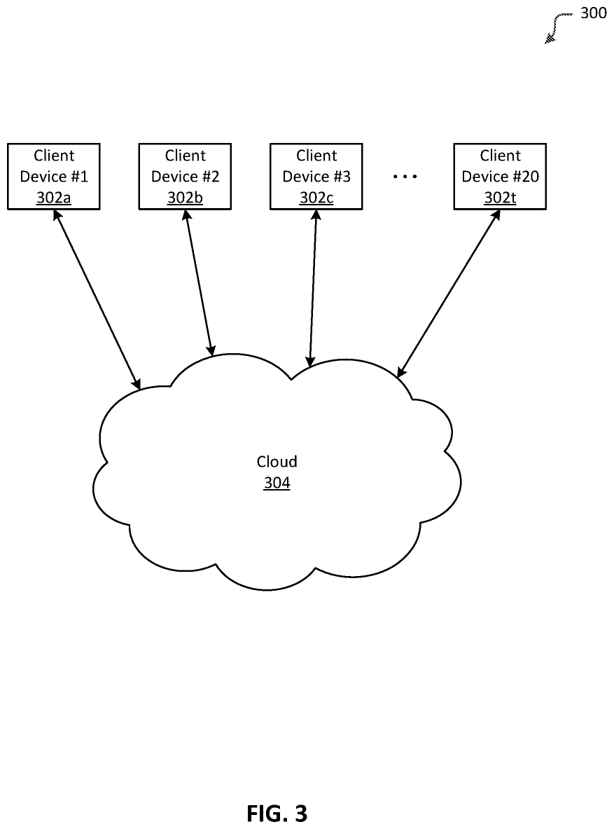

Referring to FIG. 3, shown is a diagram of a cloud computing environment 300 in which various aspects of the concepts described herein may be implemented. Cloud computing environment 300, which may also be referred to as a cloud environment, cloud computing, or cloud network, can provide the delivery of shared computing resources and/or services to one or more users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more client devices 302a-302t (such as client machines 11 and/or computing device 200 described above) may be in communication with a cloud network 304 (sometimes referred to herein more simply as a cloud 304). Cloud 304 may include back-end platforms such as, for example, servers, storage, server farms, or data centers. The users of clients 302a-302t can correspond to a single organization/tenant or multiple organizations/tenants. More particularly, in one implementation, cloud computing environment 300 may provide a private cloud serving a single organization (e.g., enterprise cloud). In other implementations, cloud computing environment 300 may provide a community or public cloud serving one or more organizations/tenants.

In some embodiments, one or more gateway appliances and/or services may be utilized to provide access to cloud computing resources and virtual sessions. For example, a gateway, implemented in hardware and/or software, may be deployed (e.g., reside) on-premises or on public clouds to provide users with secure access and single sign-on to virtual, SaaS, and web applications. As another example, a secure gateway may be deployed to protect users from web threats.

In some embodiments, cloud computing environment 300 may provide a hybrid cloud that is a combination of a public cloud and a private cloud. Public clouds may include public servers that are maintained by third parties to client devices 302a-302t or the enterprise/tenant. The servers may be located off-site in remote geographical locations or otherwise.

Cloud computing environment 300 can provide resource pooling to serve clients devices 302a-302t (e.g., users of client devices 302a-302n) through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can include or provide monitoring services to monitor, control, and/or generate reports corresponding to the provided shared resources and/or services.

In some embodiments, cloud computing environment 300 may provide cloud-based delivery of various types of cloud computing services, such as Software as a service (Saas), Platform as a Service (PaaS), Infrastructure as a Service (IaaS), and/or Desktop as a Service (DaaS), for example. IaaS may refer to a user renting the use of infrastructure resources that are needed during a specified period. IaaS providers may offer storage, networking, servers, or virtualization resources from large pools, allowing the users to quickly scale up by accessing more resources as needed. PaaS providers may offer functionality provided by IaaS, including, e.g., storage, networking, servers, or virtualization, as well as additional resources such as, for example, operating systems, middleware, and/or runtime resources. SaaS providers may offer the resources that PaaS provides, including storage, networking, servers, virtualization, operating systems, middleware, or runtime resources. SaaS providers may also offer additional resources such as, for example, data and application resources. DaaS (also known as hosted desktop services) is a form of virtual desktop service in which virtual desktop sessions are typically delivered as a cloud service along with the applications used on the virtual desktop.

FIG. 4 is a diagram showing integration of proactive web element change identification and mitigation process with a continuous integration and continuous deployment (CI/CD) pipeline 400 for an application, in accordance with an embodiment of the present disclosure. An organization that develops applications may implement and utilize CI/CD pipeline 400 to automatically build, test, and deploy new versions of applications. In brief, a developer of an application can commit code for the application, including changes to the code to a code repository, such as, for example, GitHub, which starts CI/CD pipeline 400 process for the application. (Indicated by reference numeral 402 in FIG. 4.) The code travels through the various stages of CI/CD pipeline 400, such as trigger build, build, notify of build outcome, run test, notify of test outcome, and deliver build, and the built application is finally deployed to production. (Indicated by reference numeral 404 in FIG. 4.)

As shown in FIG. 4, the various stages of a proactive web element change identification and mitigation process 406 can integrate with CI/CD pipeline 400 at or as part of the build stage of CI/CD pipeline 400 for the application. For example, as part of building the application, the stages of proactive web element change identification and mitigation process 406, such as fetch a web elements repository for the application, validate the locators in the web elements repository for correctness, identify the changed elements in the application (e.g., identify the failed locators), generate new locators for the changed elements, and update the web elements repository with the new locators, can be performed. Upon completion of proactive web element change identification and mitigation process 406, handshake can be given back to the notify of build outcome stage of CI/CD pipeline 400 for the application for processing of the remaining stages of CI/CD pipeline 400 to test and deploy the built application. Integrating proactive web element change identification and mitigation process 406 in this way validates the correctness of the locators in the web elements repository for the application before running the test automation (e.g., before performing the run test stage of CI/CD pipeline 400).

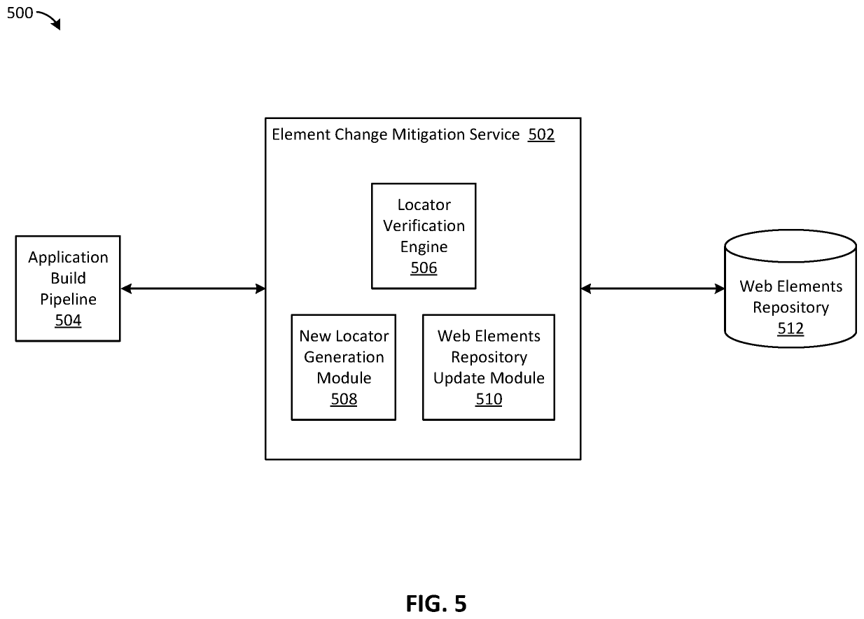

Referring now to FIG. 5, shown is a block diagram of an illustrative system 500 for proactive identification and mitigation of web element changes, in accordance with an embodiment of the present disclosure. Illustrative system 500 includes an element change mitigation service 502 configured to integrate with an application build pipeline 504. Application build pipeline 504 of FIG. 5 can be the same or similar to CI/CD pipeline 400 of FIG. 4.

In embodiments, element change mitigation service 502 can be provided as a service (e.g., a microservice) within a cloud computing environment, which may be the same as or similar to cloud computing environment 300 of FIG. 3. For example, an organization such as a company, an enterprise, or other entity that develops applications (e.g., web applications), for instance, may implement and use element change mitigation service 502 to proactively identify and mitigate changes to elements in an application. Element change mitigation service 502 may be implemented as computer instructions executable to perform the corresponding functions disclosed herein. Element change mitigation service 502 can be logically and/or physically organized into one or more components. In the example of FIG. 5, element change mitigation service 502 includes a locator verification engine 506, a new locator generation module 508, and a web elements repository update module 510.

Locator verification engine 506 is operable to validate correctness of locators for elements on the various pages of an application. For example, as part of a build stage of application build pipeline 504 for an application, locator verification engine 506 can traverse a web elements repository 512 for the application to identify the locators in web elements repository 512. The, for each identified locator in web elements repository 512, locator verification engine 506 can validate the locator for effectiveness in identifying an element on a page of the application. That is, locator verification engine 506 can check to determine whether a current element represented by the locator's current value in the web elements repository 512 is located on the page of the application. If the current element is located on the page of the application, locator verification engine 506 can verify the locator to be correct and maintain the locator as is within web elements repository 512. If the current element is not located on the page of the application, locator verification engine 506 can determine that the locator is a failed locator. In the case of a failed locator, locator verification engine 506 can initiate or otherwise trigger new locator generation module 508 to generate a new locator for the failed locator (e.g., generate a new locator to replace the failed locator).

New locator generation module 508 is operable to generate new locators for failed locators. A new locator generated for a failed locator identifies a new element on the page of the application that is different than the current element that corresponds to the failed locator. For example, new locator generation module 508 can use the failed locator's current value in web elements repository 512 (e.g., the current element that correspond to the failed locator) to identify a new element on the page of the application. In some embodiments, new locator generation module 508 can identify a new element based on similarity scores assigned to the different elements on the page of the application. A similarity score assigned to each element on the page of the application represents the similarity of each element (e.g., similarity of one or more attributes of each element) to the current element that corresponds to the failed locator. For example, new locator generation module 508 can use a similarity algorithm or other distance measure technique to assign similarity scores to the different elements on the page of the application. In some embodiments, new locator generation module 508 can identify the element on the page of the application that is most similar to the current element (e.g., the element having the highest similarity score) as the new element.

New locator generation module 508 can then generate a new locator that identifies the new element on the page of the application. For example, new locator generation module 508 can update the current value of the failed locator with new locator values to identify the new element. As a result, the new locator maintains (or “keeps”) the name of the failed locator. Maintaining the name of the failed locator in this way is advantageous in that the test scripts designed to test the application need not be changed since these test scripts can be designed to reference or use locator names (e.g., the handler classes for accessing the elements are generated using the locator names). As a result, even if there is a change to an element, no change to existing test scripts is needed and the existing test scripts may be used as is. Upon generating a new locator, new locator generation module 508 can initiate or otherwise trigger web elements repository update module 510 to update web elements repository 512 with the new locator.

Web elements repository update module 510 is operable to update web elements repository 512 with new locators. For example, for a particular new locator generated for a failed locator, web elements repository update module 510 can replace the failed locator in web elements repository 512 with the new locator. In some embodiments, web elements repository update module 510 can maintain the failed locator's value (e.g., keep the current element that corresponds to the failed locator) in, for example, a data store. Maintaining the value of the failed locator allows a user (e.g., application developer) to revert to the previous value of the locator in cases where the new locator is ineffective, for instance.

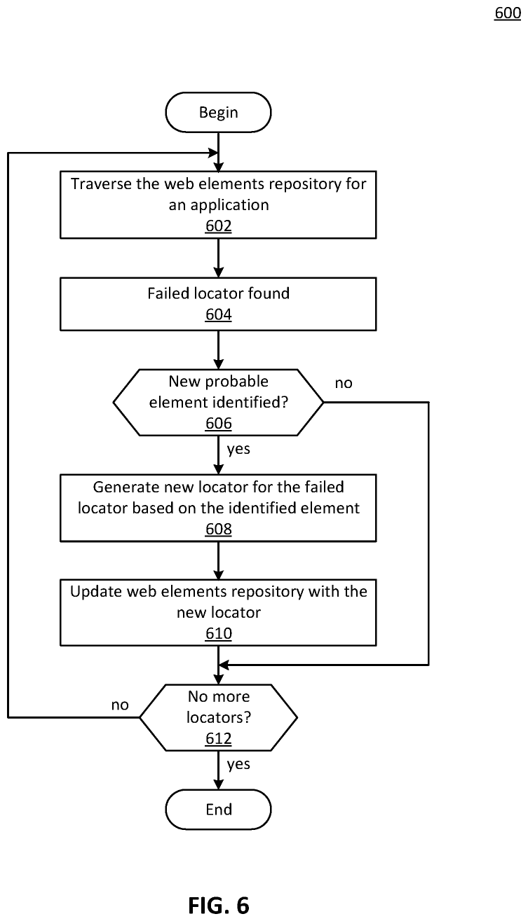

FIG. 6 is a flow diagram of an example process 600 for identification and mitigation of web element changes, in accordance with an embodiment of the present disclosure. Illustrative process 600 may be implemented, for example, within element change mitigation service 502 of FIG. 5. For purposes of this discussion, it is assumed that a developer (e.g., developer 128 of FIG. 1) within or associated with an organization commits code for an application and indicates specifies a web elements repository (e.g., web elements repository 512 of FIG. 5) for the application. It is also assumed that the developer sends a request for a build of the application to deploy the application. In embodiments, process 600 may be performed prior to the testing of the application.

With reference to FIG. 6, process 600 begins at 602 where the web elements repository for the application may be traversed. For example, the web elements repository may be traversed to identify and validate the locators for effectiveness in identifying elements on the various pages of the application.

At 604, a failed locator may be found. The failed locator is a locator that is ineffective in identifying a current element that corresponds to the locator on a page of the application.

At 606, a check may be performed to determine whether a new probable element is identified. The new probable element is a new element on the page of the application that can be used to generate a new locator for the failed locator. For example, the new element on the page of the application for use in generating the new locator can be identified based on similarity to the current value of the failed locator, as previously described herein.

If at 606, it is determined that a new probable element is identified, then, at 608, a new locator may be generated for the failed locator based on the new element identified at 606. The generated new locator identifies the new element on the page of the application. For example, the new locator can be generated for the failed locator using the failed locator's current value in the web elements repository, as previously described herein. At 610, the web elements repository may be updated with the new locator generated at 608.

Otherwise, if, at 606, it is determined that a new probable element is not identified or subsequent to updating the web elements repository with the new locator at 610, at 612, a check may be performed to determine whether all the locators in the web elements repository have been processed. If there are locators in the web elements repository that need to be processed, process 600 may return to 602 where locators in the web elements repository that need to be processed may be identified and validated. Otherwise, if, at 612, it is determined that all the locators in the web elements repository have been processed (e.g., validated), process 600 may end.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
traversing, by a computing device, through one or more locators to validate the one or more locators, wherein each locator of the one or more locators is for an element on a page of an application; and
responsive to a determination of a failure of a locator to identify a current element on a page of the application, by the computing device:
identifying a new element on the page of the application, wherein the new element is identified based on the current element;
generating a new locator for the failed locator based on the new element; and
updating a web elements repository for the application with the new locator.

2. The method of claim 1, wherein generating the new locator includes updating the failed locator with a new value corresponding to the new element.

3. The method of claim 1, wherein the new element is identified based on a similarity of the new element to the current element.

4. The method of claim 1, wherein the new element is identified based on a similarity score assigned to the new element based on how similar the new element is to the current element.

5. The method of claim 4, wherein the similarity score represents a similarity of one or more attributes of the new element to one or more attributes of the current element.

6. The method of claim 1, wherein the new locator has a same name as the failed locator.

7. The method of claim 1, wherein the new element has a same name as the current element.

8. The method of claim 1, wherein the one or more locators validated are stored within the web elements repository for the application.

9. A computing device comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
traversing through one or more locators to validate the one or more locators, wherein each locator of the one or more locators is for an element on a page of an application; and
responsive to a determination of a failure of a locator to identify a current element on a page of the application:
identifying a new element on the page of the application, wherein the new element is identified based on the current element;
generating a new locator for the failed locator based on the new element; and
updating a web elements repository for the application with the new locator.

10. The computing device of claim 9, wherein generating the new locator includes updating the failed locator with a new value corresponding to the new element.

11. The computing device of claim 9, wherein the new element is identified based on a similarity of the new element to the current element.

12. The computing device of claim 9, wherein the new element is identified based on a similarity score assigned to the new element based on how similar the new element is to the current element.

13. The computing device of claim 12, wherein the similarity score represents a similarity of one or more attributes of the new element to one or more attributes of the current element.

14. The computing device of claim 9, wherein the new locator has a same name as the failed locator.

15. The computing device of claim 9, wherein the new element has a same name as the current element.

16. The computing device of claim 9, wherein the one or more locators validated are stored within the web elements repository for the application.

17. A non-transitory machine-readable medium encoding instructions that when executed by one or more processors cause a process to be carried out, the process including:
traversing through one or more locators to validate the one or more locators, wherein each locator of the one or more locators is for an element on a page of an application; and
responsive to a determination of a failure of a locator to identify a current element on a page of the application:
identifying a new element on the page of the application, wherein the new element is identified based on the current element;
generating a new locator for the failed locator based on the new element; and
updating a web elements repository for the application with the new locator.

18. The machine-readable medium of claim 17, wherein generating the new locator includes updating the failed locator with a new value corresponding to the new element.

19. The machine-readable medium of claim 17, wherein the new element is identified based on a similarity of the new element to the current element.

20. The machine-readable medium of claim 17, wherein the new element is identified based on a similarity score assigned to the new element based on how similar the new element is to the current element, wherein the similarity score represents a similarity of one or more attributes of the new element to one or more attributes of the current element.
